(19) United States
(12) Patent Application Publication
(10) Pub. No.: US 2011/0216154 A1
(43) Pub. Date: Sep. 8, 2011

(54) APPARATUS AND METHOD FOR OMNIDIRECTIONAL CALLER DETECTION IN VIDEO CALL SYSTEM

(75) Inventor: Haw-Seong NAM, Seoul (KR)

(73) Assignee: SAMSUNG ELECTRONICS CO. LTD., Suwon-si (KR)

(21) Appl. No.: 12/966,295

(22) Filed: Dec. 13, 2010

(30) Foreign Application Priority Data
Mar. 3, 2010 (KR) 10-2010-0018813

(51) Int. Cl. H04N 7/14

(52) U.S. Cl. 348/14.07; 348/E07.078

(57) ABSTRACT

An apparatus and method for omnidirectional caller detection in a video call system are provided. The method includes capturing an image through an omnidirectional lens, reconstructing the image captured through the omnidirectional lens into an omnidirectional image having a square form, attempting detection of a caller's face in the omnidirectional image, and generating an image for delivery from the omnidirectional image according to the detection result.

### PRIORITY

This application claims the benefit under 35 U.S.C. §119(a) of a Korean patent application filed in the Korean Intellectual Property Office on Mar. 3, 2010 and assigned Serial No. 10-2010-0018813, the entire disclosure of which is hereby incorporated by reference.

### BACKGROUND OF THE INVENTION

1. Field of the Invention

The present invention relates to a video call system. More particularly, aspects of the present invention relates to an apparatus and method for detecting an image of a caller without limitation of a position of a camera lens in a video call system.

2. Description of the Related Art

In modern society, portable terminals have become necessities for most people based on their convenience and portability. Accordingly, service providers and terminal manufacturers are providing many supplementary functions in order to increase the utilization of the portable terminals. More particularly, in recent years, as the development of a communication technology leads to an increase of a data rate, a video call service is provided.

However, there is an inconvenience in that, during a video call, a caller must always position his/her figure in front of a camera to transmit his/her image to a called party. In spite of the above inconvenience, an alternative for effectively detecting and transmitting an image of a caller to a called party has not yet been proposed. That is, there is a problem that a user frequently must adjust a position of a terminal for the sake of taking a photograph of his/her figure and, more particularly, the user cannot fully transmit his/her figure to a called party if a shaking of the terminal occurs due to, for example, the user's movement.

### SUMMARY OF THE INVENTION

An aspect of the present invention is to address at least the above-mentioned problems and/or disadvantages and to provide at least the advantages described below. Accordingly, an aspect of the present invention is to provide an apparatus and method for detecting an image of a caller without limitation of a position of a camera lens in a video call system.

Another aspect of the present invention is to provide an apparatus and method for detecting an image of a caller using an omnidirectional camera lens in a video call system.

A further aspect of the present invention is to provide an apparatus and method for generating an image for delivery depending on the number of callers detected in a video call system.

The above aspects are addressed by providing an apparatus and method for omnidirectional caller detection in a video call system.

In accordance with an aspect of the present invention, an operation method of a terminal providing a video call service is provided. The method includes capturing an image through an omnidirectional lens, reconstructing the image captured through the omnidirectional lens into an omnidirectional image having a square form, attempting detection of a caller's face in the omnidirectional image, and generating an image for delivery from the omnidirectional image according to the detection result.

In accordance with another aspect of the present invention, a terminal apparatus providing a video call service is provided. The apparatus includes a camera and a controller. The camera captures an image through an omnidirectional lens. The controller reconstructs the image captured through the omnidirectional lens into an omnidirectional image having a square form, attempts detection of a caller's face in the omnidirectional image, and generates an image for delivery from the omnidirectional image according to the detection result.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIGS. 1A and 1B are diagrams illustrating reconstruction of an omnidirectional image in a video call terminal according to an exemplary embodiment of the present invention;

FIG. 2 is a diagram illustrating a range of an image for delivery when one caller is detected in a video call terminal according to an exemplary embodiment of the present invention;

FIG. 3 is a diagram illustrating a range of an image for delivery when a plurality of callers are detected in a video call terminal according to an exemplary embodiment of the present invention;

FIG. 4 is a diagram illustrating a range of an image for delivery when no caller is detected in a video call terminal according to an exemplary embodiment of the present invention;

FIG. 5 is a flow diagram illustrating an operation procedure of a video call terminal according to an exemplary embodiment of the present invention; and

FIG. 6 is a block diagram illustrating a construction of a video call terminal according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but are merely used by the inventor to enable a clear and consistent understanding of the invention. Accordingly, it should be apparent to those skilled in the art that the following description of exemplary embodiments of the present invention are provided for purposes of illustration only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to skill in the art, may occur in amounts that do not preclude the effect the characteristic was intended to provide.

Exemplary embodiments of the present invention will be described herein below with reference to the accompanying drawings. In the following description, well-known functions or constructions are not described in detail since they would obscure the invention in unnecessary detail.

A technology for detecting an image of a caller without limitation of a position of a camera lens in a video call system according to exemplary embodiments of the present invention is described below. In the present disclosure, the video call system denotes a user terminal having a communication function, and may include, for example, a cellular phone, a Personal Communication System (PCS), a Personal Digital Assistant (PDA), an International Mobile Telecommunication-2000 (IMT-2000) terminal, and the like. For convenience in the following description, the user terminal providing the video call service is referred as a ‘video call terminal’.

Exemplary embodiments of the present invention use a means for acquiring an onmidirectional image to detect an image of a caller without limitation of a position of a camera lens. As a method for acquiring the omnidirectional image, there are a method using a camera lens such as a fisheye lens and a method using a hemispherical reflector object.

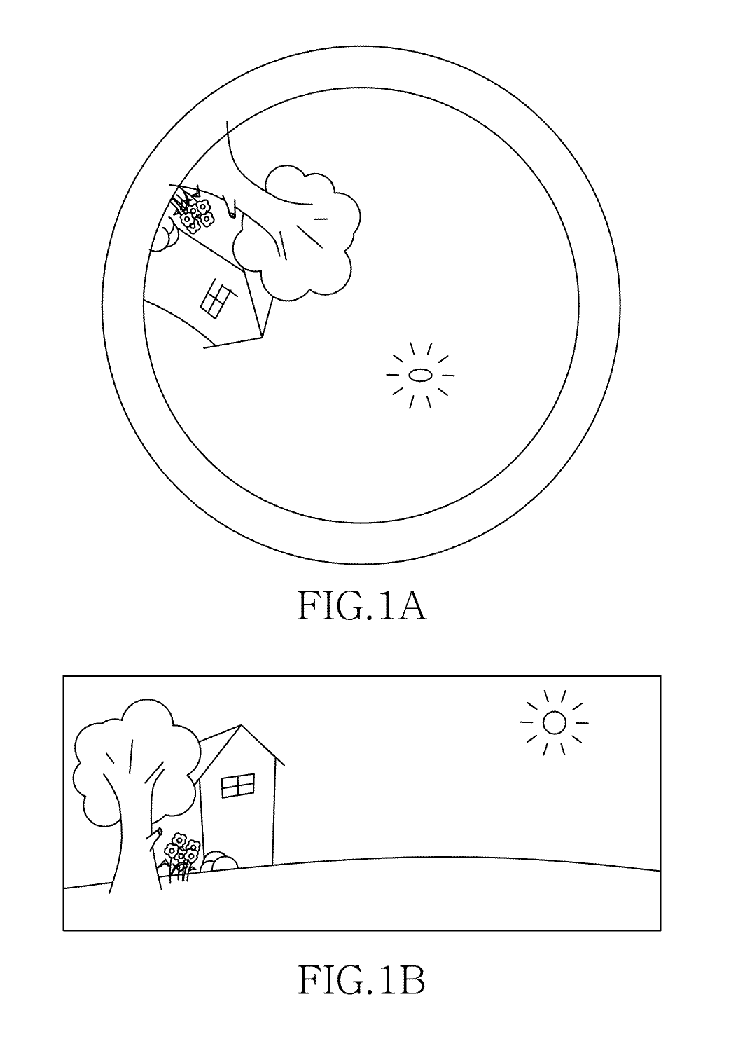

FIGS. 1A and 1B are diagrams illustrating reconstruction of an omnidirectional image in a video call terminal according to an exemplary embodiment of the present invention.

Referring to FIGS. 1A and 1B, an omnidirectional image can be obtained, for example. An image of FIG. 1A, obtained through an omnidirectional lens, can be reconstructed into an omnidirectional image having a square form of FIG. 1B depending on a specification (e.g., a magnification, a viewing angle, etc.) of the lens.

Accordingly, the video call terminal reconstructs the image of FIG. 1A into the omnidirectional image of FIG. 1B, and determines if an image of a caller is contained within the omnidirectional image. If it is determined that the image of the caller is contained within the omnidirectional image, the video call terminal detects the image of the caller in the omnidirectional image, and generates an image that is modified for transmission with the caller as a center. For description convenience, ‘the image that is modified for transmission’ is referred as an ‘image for delivery’.

The following is an exemplary process of generating an image for delivery. The process of generating the image for delivery is divided into three cases:

1) One caller is detected,

2) Plurality of callers are detected, and

3) No caller is detected.

Here, the caller detection is achieved by detecting a caller's face within an image. In detecting the caller's face, exemplary embodiments of the present invention can use a face detection technique that is well known in the art. For example, an Adaptive Boosting (AdaBoost) learning algorithm proposed by ‘Yoav Freund’ can be used. The AdaBoost technique is a boosting method for configuring a plurality of weak classifiers of poor performance to a strong classifier, and exhibits a fast face detection speed and a high face detection rate using a Haar-like feature and a cascade structure. In addition, a face detection technique applying Fisher Linear Discriminant (FLD) that is a classification algorithm, a technique based on Support Vector Machine (SVM), a technique using a neural network, a technique using fuzzy and neural networks, and the like can be used.

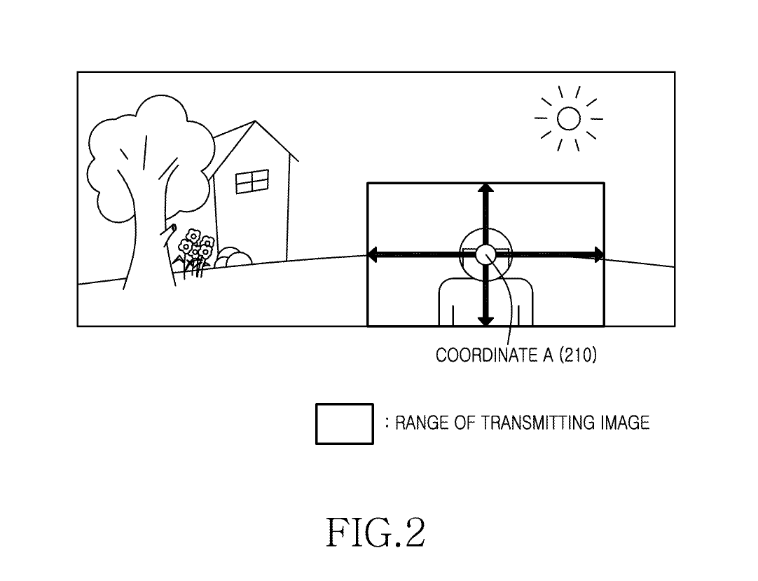

FIG. 2 is a diagram illustrating a range of an image for delivery when one caller is detected in a video call terminal according to an exemplary embodiment of the present invention.

Referring to FIG. 2, a caller's face is detected at a coordinate A 210. Accordingly, the video call terminal configures an image for delivery such that the coordinate A 210 becomes the center of the image for delivery. That is, the video call terminal determines a range of the image for delivery by determining amounts of up/down/left/right extensions to coordinate with a size of the image for delivery from the coordinate A 210. The up/down extension and the left/right extension are accomplished depending on a width to length ratio of the image for delivery, and are accomplished in consideration of a size defined in a format of the image for delivery. Also, the sizes of the up extension and the down extension are the same as each other in principle, but can be asymmetric depending on a position of a normal coordinate.

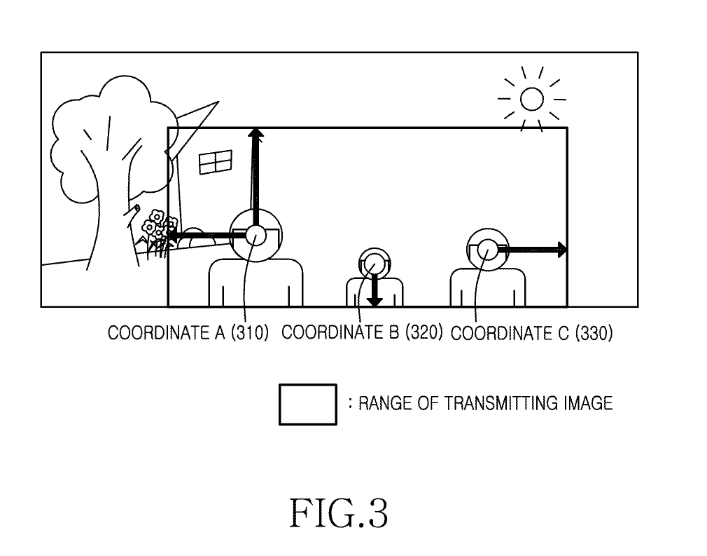

FIG. 3 is a diagram illustrating a range of an image for delivery when a plurality of callers are detected in a video call terminal according to an exemplary embodiment of the present invention.

Referring to FIG. 3, a plurality of caller's faces are detected at a coordinate A 310, a coordinate B 320, and a coordinate C 330. Accordingly, the video call terminal determines a range of an image for delivery by determining amounts of up/down/left/right extensions to coordinate with a size of the image for delivery from the coordinates 310, 320, and 330. At this time, the video call terminal selects one normal coordinate per direction for each of the extension directions (i.e., each of the up direction, the down direction, the left direction, and the right direction). In FIG. 3, the coordinate A 310 is selected as a normal coordinate for the up extension and left extension, the coordinate B 310 as a normal coordinate for the down extension, and the coordinate C 320 as a normal coordinate for the right extension. The up/down extension and the left/right extension are accomplished depending on a width to length ratio of the image for delivery, and are accomplished such that an image of all callers is contained within the image for delivery. Also, the sizes of the up extension and the down extension are the same as each other in principle, but can be asymmetric when an image to be extended up or down is insufficient. When a size of the image for delivery is greater than a size defined in a format of the image for delivery by determining the range of the image for delivery such that the image of all callers is contained within the image for delivery, the video call terminal reduces the size of the image for delivery to the size defined in the format.

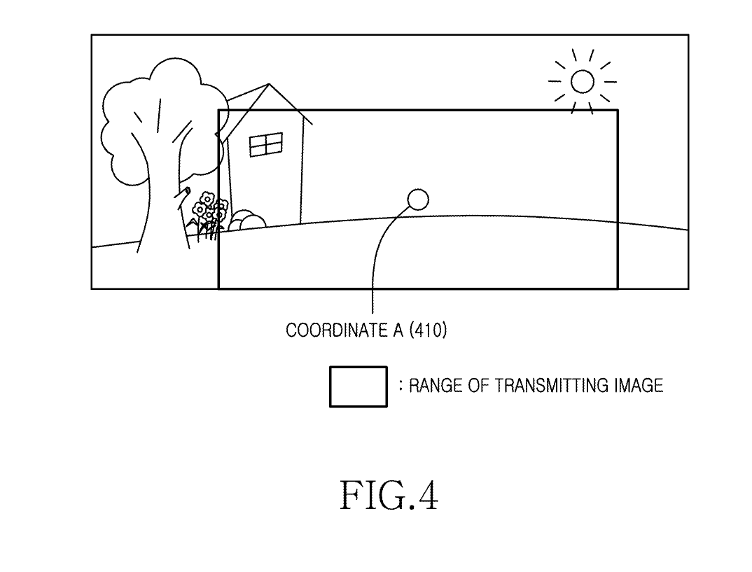

FIG. 4 is a diagram illustrating a range of an image for delivery when no caller is detected in a video call terminal according to an exemplary embodiment of the present invention.

Referring to FIG. 4, no caller's face is detected. Accordingly, the voice call terminal determines a range of an image for delivery by determining amounts of up/down/left/right extensions to coordinate with a size of the image for delivery from a coordinate A 410 that is the center of the omnidirectional image. At this time, the up/down extension and the left/right extension are accomplished depending on a width to length ratio of the image for delivery, and are accomplished as much as a size defined in a format of the image for delivery.

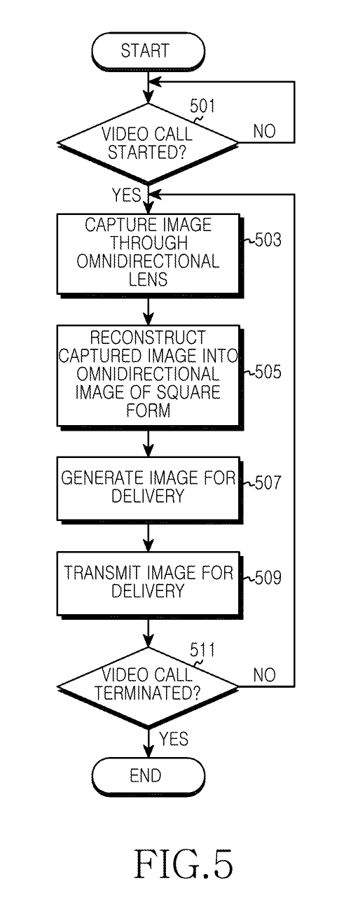

FIG. 5 illustrates an operation procedure of a video call terminal according to an exemplary embodiment of the present invention.

Referring to FIG. 5, in step 501, the video call terminal identifies if a video call is started. The video call can be started by user's manipulation. For example, the video call can be started by user's executing a video call application.

If it is determined in step 501 that the video call is started, the video call terminal proceeds to step 503 and captures an image through an omnidirectional lens provided in the video call terminal. For example, the video call terminal captures an image similar to that illustrated in FIG. 1A through the omnidirectional lens.

After capturing the image through the omnidirectional lens in step 503, the video call terminal proceeds to step 505 and reconstructs the image captured through the omnidirectional lens into an omnidirectional image having a square form. At this time, the video call terminal deforms the captured image into the omnidirectional image of the square form depending on a specification such as a magnification of the omnidirectional lens, a viewing angle, and the like. For example, the video call terminal deforms the image of FIG. 1A into an image of FIG. 1B.

In step 507, the video call terminal generates an image for delivery for video call from the omnidirectional image. At this time, an operation of the video call terminal is different depending on the number of callers detected in the omnidirectional image as follows. First, when one caller's face is detected, the video call terminal determines a range of an image for delivery by determining amounts of up/down/left/right extensions to coordinate with a size of the image for delivery from a center coordinate of the caller's face, and extracts an image within the determined range. Second, when a plurality of callers' faces are detected, the video call terminal selects one normal coordinate per direction for each of the up direction, the down direction, the left direction, and the right direction, determines a range of an image for delivery by determining up/down/left/right extensions from each normal coordinate, and extracts an image within the determined range. At this time, the video call terminal determines the range of the image for delivery such that an image of all callers is contained within the image for delivery. Third, when no caller's face is detected, the video call terminal determines a range of an image for delivery by performing up/down/left/right extension from a center coordinate of the omnidirectional image, and extracts an image within the determined range. However, in the aforementioned cases, if a size of the extracted image is greater than a size defined in a format of the image for delivery, the video call terminal reduces the size of the image for delivery to the size defined in the format.

After generating the image for delivery, the video call terminal proceeds to step 509 and transmits the image for delivery to a called party terminal. That is, the video call terminal processes the image for delivery in compliance with an image transmission standard for a video call, generates data packets in compliance with a communication standard, and transmits the data packets through a wired or wireless channel. For example, the processing may include image compression.

After that, the video call terminal proceeds to step 511 and determines if the video call is terminated. The video call can be terminated by the user's manipulation or by the worsening of a call connection state. For example, the video call can be terminated by the user's terminating of a video call application. If it is determined in step 511 that the video call is terminated, the video call terminal terminates the procedure according to the exemplary embodiment of the present invention. On the contrary, if it is determined in step 511 that the video call is not terminated, the video call terminal returns to step 503.

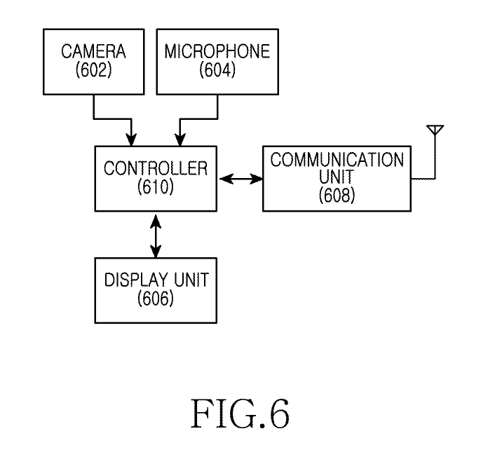

FIG. 6 illustrates a construction of a video call terminal according to an exemplary embodiment of the present invention.

Referring to FIG. 6, the video call terminal includes a camera 602, a microphone 604, a display unit 606, a communication unit 608, and a controller 610.

The camera 602 is a means for converting light into an electrical signal, and provides an electrical signal of a generated image to the controller 610. That is, the camera 602 includes a lens and an optical sensor, and converts light input through the lens into an electrical signal using the optical sensor. More particularly, according to an exemplary embodiment of the present invention, the camera 602 has an omnidirectional lens. For example, the omnidirectional lens can be a fisheye lens. The microphone 604 is a means for converting a voice into an electrical signal, and provides an electrical signal of a generated voice to the controller 610.

The display unit 606 displays state information generated during an operation of the video call terminal, and numerals, characters, images, etc. according to execution of an application program. That is, the display unit 606 displays video data provided from the controller 610, as a visual picture. The display unit 606 can be, for example, a Liquid Crystal Display (LCD), an Organic Light-Emitting Diode (OLED), and the like.

The communication unit 608 provides an interface for transmission/reception of a signal through a wireless channel. That is, the communication unit 608 converts transmission data into a Radio Frequency (RF) signal and transmits the RF signal, and converts an RF signal received through an antenna into reception data. At this time, the communication unit 608 performs conversion between data and an RF signal in compliance with the standard of a communication system. In FIG. 6, it is illustrated that the communication unit 608 is a wireless communication means having an antenna. However, the communication unit 608 can provide an interface for wired communication according to another exemplary embodiment of the present invention.

The controller 610 controls general functions of the video call terminal For example, the controller 610 executes an application for providing a video call service. Upon the video call service provision, the controller 610 generates image data for a video call using an electrical signal of an image provided from the camera 602, and generates voice data for the video call using an electrical signal of a voice provided from the microphone 604. And, the controller 610 generates data packets for video communication including the image data and the voice data, and transmits the data packets to a called party terminal through the communication unit 608. More particularly, according to an exemplary embodiment of the present invention, the controller 610 detects a caller from an image captured through the omnidirectional lens of the camera 602, and generates an image for delivery containing the caller. An exemplary function of the controller 610 for generation of the image for delivery is given as follows.

If an electrical signal of an image captured through the omnidirectional lens is provided from the camera 602, the controller 610 converts the electrical signal into data, and reconstructs the image captured through the omnidirectional lens into an omnidirectional image having a square form. After that, the controller 610 generates an image for delivery for a video call from the omnidirectional image. At this time, an operation of the video call terminal is different depending on the number of callers detected in the omnidirectional image as follows. First, when one caller's face is detected, the controller 610 determines a range of an image for delivery by performing up/down/left/right extensions from a center coordinate of the caller's face, and extracts an image within the determined range. Second, when a plurality of callers' faces are detected, the controller 610 selects one normal coordinate per direction for each of the up direction, the down direction, the left direction, and the right direction, determines a range of an image for delivery by performing up/down/left/right extensions from each normal coordinate, and extracts an image within the determined range. At this time, the controller 610 determines the range of the image for delivery such that an image of all callers is contained within the image for delivery. Third, when no caller's face is detected, the controller 610 determines a range of an image for delivery by performing as much up/down/left/right extension as the image for delivery from a center coordinate of the omnidirectional image, and extracts an image within the determined range. However, in the aforementioned cases, when a size of the extracted image is greater than a size defined in a format of the image for delivery, the controller 610 reduces the size of the image for delivery to the size defined in the format.

As described above, exemplary embodiments of the present invention can enhance the convenience of a user using a video call service by making use of an omnidirectional camera lens for caller detection in a video call system.

While the invention has been shown and described with reference to exemplary embodiments thereof, it will be understood by those skilled in the art that various changes in form and details may be made therein without departing from the spirit and scope of the invention as defined by the appended claims and their equivalents.

What is claimed is:

1. An operation method of a terminal for providing a video call service, the method comprising:
capturing an image through an omnidirectional lens;
reconstructing the image captured through the omnidirectional lens into an omnidirectional image having a square form;
attempting detection of a caller's face in the omnidirectional image; and
generating an image for delivery from the omnidirectional image according to the detection result.

2. The method of claim 1, wherein the reconstructing of the captured image into the omnidirectional image having the square form comprises deforming the captured image into the omnidirectional image having the square form depending on a specification of the omnidirectional lens.

3. The method of claim 1, wherein the generating of the image for delivery comprises:
when one caller's face is detected, selecting a center coordinate of the one caller's face as a normal coordinate;
determining a range of the image for delivery by performing up/down/left/right extension from the normal coordinate; and
extracting an image within the determined range.

4. The method of claim 3, wherein the generating of the image for delivery comprises, when a size of the extracted image is greater than a size defined in a format of the image for delivery, reducing the size of the image for delivery to the size defined in the format.

5. The method of claim 1, wherein the generating of the image for delivery comprises:
when a plurality of callers' faces are detected, selecting a normal coordinate for each of the up direction, the down direction, the left direction, and the right direction among center coordinates of the plurality of callers' faces;
determining a range of the image for delivery by performing up/down/left/right extension from each of the normal coordinates; and
extracting an image within the determined range.

6. The method of claim 5, wherein the determining of the range of the image for delivery comprises determining the range of the image for delivery such that an image of a plurality of callers is contained within the image for delivery.

7. The method of claim 6, wherein the generating of the image for delivery comprises, when a size of the extracted image is greater than a size defined in a format of the image for delivery, reducing the size of the image for delivery to the size defined in the format.

8. The method of claim 1, wherein the generating of the image for delivery comprises:
when no caller's face is detected, selecting a center coordinate of the omnidirectional image as a normal coordinate;
determining a range of the image for delivery by performing up/down/left/right extension from the normal coordinate; and
extracting an image within the determined range.

9. The method of claim 8, wherein the generating of the image for delivery comprises, when a size of the extracted image is greater than a size defined in a format of the image for delivery, reducing the size of the image for delivery to the size defined in the format.

10. The method of claim 1, further comprising transmitting the image for delivery to a called party terminal.

11. A terminal apparatus for providing a video call service, the apparatus comprising:
a camera for capturing an image through an omnidirectional lens; and
a controller for reconstructing the image captured through the omnidirectional lens into an omnidirectional image having a square form, for attempting detection of a caller's face in the omnidirectional image, and for generating an image for delivery from the omnidirectional image according to the detection result.

12. The apparatus of claim 11, wherein the controller deforms the captured image into the omnidirectional image having the square form depending on a specification of the omnidirectional lens.

13. The apparatus of claim 11, wherein, when one caller's face is detected, the controller selects a center coordinate of the one caller's face as a normal coordinate, determines a range of the image for delivery by performing up/down/left/right extension from the normal coordinate, and extracts an image within the determined range.

14. The apparatus of claim 13, wherein, when a size of the extracted image is greater than a size defined in a format of the image for delivery, the controller reduces the size of the image for delivery to the size defined in the format.

15. The apparatus of claim 11, wherein, when a plurality of callers' faces are detected, the controller selects a normal coordinate for each of the up direction, the down direction, the left direction, and the right direction among center coordinates of the plurality of callers' faces, determines a range of the image for delivery by performing up/down/left/right extension from each of the normal coordinates, and extracts an image within the determined range.

16. The apparatus of claim 15, wherein the controller determines the range of the image for delivery such that an image of a plurality of callers is contained within the image for delivery.

17. The apparatus of claim 16, wherein, when a size of the extracted image is greater than a size defined in a format of the image for delivery, the controller reduces the size of the image for delivery to the size defined in the format.

18. The apparatus of claim 11, wherein, when no caller's face is detected, the controller selects a center coordinate of the omnidirectional image as a normal coordinate, determines a range of the image for delivery by performing up/down/left/right extension from the normal coordinate, and extracts an image within the determined range.

19. The apparatus of claim 18, wherein, when a size of the extracted image is greater than a size defined in a format of the image for delivery, the controller reduces the size of the image for delivery to the size defined in the format.

20. The apparatus of claim 11, further comprising a communication unit for transmitting the image for delivery to a called party terminal.
